(19) United States
(12) Patent Application Publication
(10) Pub. No.: US 2007/0056132 A1
(43) Pub. Date: Mar. 15, 2007

(54) Paint roller

(75) Inventors: Tosirou Yamaguchi, Osaka (JP); Toshikazu Ohyama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Kuraray Co., Ltd., Kurashiki-shi (JP); MARU-T OHTSUKA CORP., Tokyo (JP)

(21) Appl. No.: 10/575,930

(22) PCT Filed: Oct. 5, 2004
(86) PCT No.: PCT/JP04/14619

§ 371 Date: Apr. 14, 2006

(30) Foreign Application Priority Data
Oct. 16, 2003 (JP) 2003-355921

(51) Int. Cl. B05C 17/02

(52) U.S. Cl. 15/230; 15/230.13; 15/230.19; 492/29

(57) ABSTRACT

A paint roller comprises a liquid-impermeable tubular core member 6 with an engaging element 9 having a male structure of a separable fastener and a height of 0.3 to 4.0 mm on a surface thereof, and a cover member 8 with a female structure and a loop on the inner surface capable of male-female engaging with the engaging element on the surface of the core member. The density of the engaging element on the surface of the core member is 30 to 150/cm². Thus, in such paint roller, when the cover member becomes dirty, damaged, or worn, the cover member can be exchanged to a new cover member. Such that, a roller body is repeatedly usable, and the paint roller can provide a good painted surface. Moreover, there is also provided an effect roller in which a painting pattern can be changed optionally.

### TECHNICAL FIELD

The present invention relates to a paint roller. More specifically, the present invention relates to a paint roller comprising a tubular core member (tubular core part) and a cover member attached on the surface of the core member. In the paint roller, the cover member is removable from the tubular core member and easily exchangeable for a new cover member, when the cover member becomes dirty, damaged, or worn. In the paint roller of the present invention, the tubular core member is reusable repeatedly. Moreover, the present invention provides a paint roller with which a design (or figure, marking) having a desired pattern, mark and others can be painted on a surface of an object to be painted. Further, in the paint roller, a kind or content of a painting pattern on a surface of an object to be painted is freely changeable according to each aspect.

### BACKGROUND ART

Conventionally, a paint roller has been produced by spirally (or helically) winding (or wrapping) a cover member such as a fabric around a tubular core member which is formed from a cardboard (or a chipboard) or a resin-impregnated paper and bonding the cover member to the tubular core member, followed by inserting a handle into the tubular core member to attach the handle to the tubular core member. Specifically, the paint roller is produced by a series of steps as follows: a step for simultaneously supplying (or feeding) a plurality of strip-shaped (band-shaped) cardboards or resin-impregnated papers in conjunction with spirally winding the strip-shaped (band-shaped) cardboards or resin-impregnated papers around a mandrel with applying an adhesive, to form a tubular core member; a step for winding a strip-shaped (band-shaped) fabric (cover member) onto the tubular core member with applying an adhesive to the inner (back) surface of the fabric (cover member); a step for cutting a laminate (laminated product) comprising the core member and the cover member into an appropriate length; a step for heating the laminate in a heating furnace to harden (or cure) the resin which is impregnated into the paper, as well as to dry or harden the adhesive; a step for cutting the cured laminate into a given size of a roller; a step for arranging (or adjusting) a fluff (or fuzz) on the surface with a card cloth brush and the like for finish; a step for attaching a handle; and others. Thus, since such a process requires an extremely large number of the steps and is very complex, the production of the paint roller requires much labor and time. Further, in the case where a solvent-based adhesive is used in the step for winding a cardboard or resin-impregnated paper around a mandrel, or the step for winding a strip-shaped fabric for the cover member around the tubular core member, and the like, the organic solvent in the adhesive causes some problems. For example, the organic solvent corrodes the tubular paper formed by winding the strip-shaped paper around the mandrel. Further, due to the organic solvent, deterioration of the working environment, pollution of natural environment, and the like occur. Therefore, it is necessary to select an adhesive not causing such problems.

In order to resolve the aforementioned problems of the related art, U.S. Pat. No. 5,572,970 specification (Patent document 1) proposes a process for producing a paint roller, which comprises spirally winding a tape (strip) comprising a thermoplastic resin such as a polypropylene around a mandrel to form a core tube instead of forming the core tube from a cardboard or a resin-impregnated paper, applying an adhesive comprising a molten resin such as a molten polypropylene to the core tube, spirally winding a strip-shaped fabric cover member to bond the fabric cover to the core tube by use of the adhesive, then cutting the resulting roller into a given size, conditioning a fluff on the surface with a card cloth brush, and attaching a handle to the core tube.

Additionally, U.S. Pat. No. 4,692,975 specification (Patent document 2) proposes another process for producing a paint roller, the process which comprises heat-fusing a surface of a thermoplastic core tube with a heat source which is located parallel to the core tube, with helically winding a fabric cover over the surface of the core tube to obtain a paint roller in which the fabric cover is integrally bonded to the core tube without applying an adhesive between the core tube and the fabric cover.

Since there is no need to use an adhesive containing an organic solvent in these processes, these processes do not cause problems such as deterioration of the working environment and pollution of natural environment due to organic solvents, and further these processes are excellent in safety and sanitary. However, in the paint roller obtained from these processes, the core tube (tubular core member) and the cover member are strongly bounded and integrated. Accordingly, when the cover member becomes dirty, damaged, or worn, even if there is no damage in the core tube (tubular core member), it is necessary to discard the whole paint roller. Thus, these processes are problematic in an effective utilization of resources, economical efficiency and the like.

From the above viewpoint, Japanese Utility Model Application Laid Open No. 76879/1982 (JP-U-57-76879) (Patent document 3) proposes a paint roller comprising a paint roller body (tubular core member) and a cover member wound along with a guide projection (or protuberance) line which is formed spirally on the surface of the paint roller body (tubular core member), wherein a pressure-sensitive adhesive is applied to the inner surface of the cover member in order to reuse the paint roller body (tubular core member). In such a paint roller, when a cover member of the paint roller becomes dirty or damaged, reuse of the paint roller body is achieved by exchanging only the cover member.

In the paint roller described in this document, since the cover member is adhered (or bonded) to the surface of the paint roller body by use of the pressure-sensitive adhesive, when the cover member becomes dirty or damaged, the cover member can be removed from the paint roller body, and another new cover member can be adhered to the body. Thereby, the paint roller body is reusable.

However, since a fabric used for a cover member of the paint roller needs to uniformly hold enough amount of a paint upon a painting work operation, the fabric is much thicker than a substrate such as a paper or a resin-impregnated cloth used in a general purpose adhesive tape, and further has a porous structure having many voids throughout fibers thereof. Thus, in order to apply a pressure-sensitive adhesive in a uniform thickness without excessively applying to the inner surface of such a thick and porous cover member (fabric), a special equipment(s) or a step(s) are additionally required. As a result, the production cost of the cover member having a pressure-sensitive adhesive layer is inevitably greatly increased. Accordingly, even if the paint roller body is repeatedly reusable, since the cover member becomes expensive because of the pressure-sensitive adhesive layer, such a cover member does not comply with the purpose for reducing the cost of the paint roller by preventing a throwaway of the cover member.

Further, in an environmentally friendly paint or an environmentally safe paint in resent years, because of an attempt to decrease the use of an organic solvent in a paint, the viscosity of the paint itself becomes considerably high. As a result, a paint roller used for painting with such a highly viscous paint tends to lose a fiber(s) by fiber shedding in a pile fabric constituting the cover member. In particular, the shedding is significant in the cover member comprising a sliver-knit material. In order to avoid the fiber shedding in the pile fabric constituting the cover member, it is necessary to subject the inner surface of the pile fabric to a backing process. However, it is practically difficult to subject the inner surface of the pile fabric to the backing process with smoothly applying a pressure-sensitive adhesive.

Moreover, the paint rollers of the above documents also have a spiral guide projection (or protuberance) line as a guide mean for adhering the cover member to the surface of the paint roller body (roll-shaped core member). Therefore, in many cases, the guide projection (or protuberance) line protrudes (or projects) from the cover member after winding the cover member around the paint roller body. In such a case, there is a problem that a good painting is not achieved due to a line appearing (or emerging) on the painted surface.

Further, in the case of drawing a given design, figure, and others with a paint roller, a paint roller having a predetermined design, figure, and others carved on a surface thereof, a so-called effect roller, is usually employed. Since a figure(s) to be expressed (drawn) by painting has been already pre-engraved to the surface of such a conventional effect roller, the pattern cannot be freely changed. Therefore, in the case of painting another design or figure, it is necessary to purchase or to produce another effect roller having another pre-engraved design or figure.

On the other hand, in the above described conventional paint roller, since the cover member comprising a predetermined material is spirally wound around all the surface of the core tube (tubular core member), it is difficult to draw or paint on a surface to be painted by adequately selecting or changing a design, a figure, and the like having a desired pattern with such a paint roller.

Patent document 1: U.S. Pat. No. 5,572,970

Patent document 2: U.S. Pat. No. 4,692,975

Patent document 3: JP-U-57-76879

### DISCLOSURE OF THE INVENTION

### Problems to be Solved by the Invention

It is an object of the present invention to provide a paint roller, in which a tubular core member is repeatedly usable (reusable) by exchanging only a cover member which has been dirty, damaged, or worn into a new cover member.

It is another object of the present invention to provide a paint roller, in which a cover member is conveniently and efficiently exchangeable even in the cover member being not only thick but also porous, as well as a tubular core member is reusable.

It is still other object of the present invention to provide a paint roller which can be produced safely and sanitarily in a good production efficiency by a simple step, without using an adhesive containing an organic solvent and the like, and further without employing an expensive equipment(s) or a complex step(s).

Another object of the present invention is to provide a paint roller, with which a worker (or operator) can arbitrarily and adequately exchange a design, a figure or the like to be painted, and can form a desirable design, figure or the like on a surface to be painted by using the tubular core member at the painting site.

### Means to Solve the Problems

That is, the present invention relates to a paint roller comprising a liquid-impermeable tubular core member (a liquid impermeable tubular core part) and a cover member attached exchangeably on the (outer) surface of the core member, wherein the core member is attached to the cover member with a male-female engagement of a separable fastener (hook and loop fastener) which comprises a male element [a first engaging element having a male structure (function)] and a female element [a second engaging element having a female structure (function)], and the height of the male element is 0.3 to 4.0 mm. In the paint roller, one element selected from the group consisting of the male element and the female element may be present on the surface of the core member, and the other element is present on the inner surface of the cover member. Further, the paint roller may comprise the liquid-impermeable core member and the cover member, wherein the core member comprises the male element on the surface thereof, and the cover member comprises a loop having a female structure (function) on the inner surface of the cover member. More specifically, the paint roller may comprise the liquid-impermeable tubular core member and the cover member attached on the surface of the core member, wherein the core member have a male element having a height of 0.3 to 4.0 mm on the surface thereof, the cover member has a female structure of a separable fastener, and the core member and the cover member may be engaged with an engagement (male-female engagement) between a male structure of the male element on the surface of the core member and a female structure on the inner surface of the cover member.

The density of the male element (e.g., the element density of the male element on the surface of the core member) may be about 30 to 150 per cm². In the paint roller, the cover member may be spirally wound around the surface of the core member for being attached to the core member, or the cover member having a piece(s) of a given shape and dimension is attached in a given pattern on the surface of the core member with the engagement between the male element on the surface of the core member and the inner surface of the cover member (or female structure of the inner surface of the cover member). Such a paint roller is capable of painting (printing) a paint in a given pattern. The core member (core member having a male element on the surface thereof) may comprise a separable fastener tape (e.g., a male tape) and a tubular object, wherein the fastener tape may be spirally wound around the surface of the tubular object, and the fastener tape has one element selected from the group consisting of the male element and the female element on a surface thereof. Moreover, the core member may comprise a separable fastener tape (e.g., a male tape) and a tubular object, wherein the fastener tape may be spirally wound around the surface of the tubular object, and the fastener tape has the male element on a surface thereof. The tubular object and the separable fastener tape (e.g., a maple tape) may be made of a synthetic resin. Further, the cover member may be a fabric having a pile on an upper surface thereof and having a loop on an under surface thereof, wherein the loop is engaged with the male element on the surface of the core member with the engagement. Furthermore, the cover member may comprise a base (a ground) which is woven or knitted from at least a thread having a loop. The cover member may be a fabric having a loop on an inner surface thereof, and the loop is capable of engaging with the male element on the surface of the core member by means of the engagement. Moreover, the cover member may be a fabric having a pile on an upper surface thereof and containing a heat-fusing fiber in a base constituting the fabric, wherein in the base, the heat-fusing fiber may be heat-welded together with other heat-fusing fiber(s), as well as with other fiber(s).

### EFFECTS OF THE INVENTION

In the paint roller of the present invention, when an exchange of the cover member is required due to the dirt, damage or wearing of the cover member, the cover member is easily removable from the surface of the tubular core member by hand and the like, and a new cover member can be attached extremely simply and firmly to the core member by an engagement (connection) (e.g., an engagement between the male element on the surface of the tubular core member and the female structure on the inner surface of the cover member). Such that, the tubular core member can be used repeatedly. Moreover, since the mechanism of the engagement is utilized, even if the cover member is not only thick but also porous, the cover member can be exchanged conveniently and efficiently, and the tubular core member is reusable.

Further, in the paint roller of the present invention, an engagement strength between the male element [e.g., a first (engaging) element having a male structure, which exists on the surface of the tubular core member] and the female element (e.g., a loop on the inner surface of the cover member) can be held in high level. Further, no gap or void occurs at the boundary between the surface of the tubular core member and the inner surface of the cover member. Accordingly, a stain on a surface to be painted or a painting defect due to a paint leakage does not occur, by preventing the paint from entering to the boundary part.

Moreover, according to the present invention, the cover member to be attached to the surface of the tubular core member can comprise a piece of the cover member having a desired shape and dimension, and the desired number of the piece of the cover member can be easily attached to the surface of the tubular core member by virtue of the engagement action in a desired pattern, by placing the desired number of cover member pieces, and the pattern can be optionally changed if necessary. Thus, any design, figure or the like can be very easily painted on a surface to be painted by one paint roller (or tubular core member).

Further, the paint roller of the present invention can be produced extremely simply and in good production efficiency, without an organic solvent or the like which is harmful to the environment.

### BRIEF DESCRIPTION OF THE DRAWINGS

FIG. 1 is a schematic view showing shapes of examples in which each male element present on the surface of a tubular core member constituting a paint roller of the present invention.

FIG. 2 is a view showing a process for producing a tubular body (preparatory roller) for a paint roller, and an example of a tubular core member produced by this process. FIG. 2 (a) is a schematic view showing an example of a process for producing a tubular body (preparatory roller) for a paint roller having a cover member attached to the surface of the tubular core member. FIG. 2 (b) is a perspective schematic view showing an example of a tubular core member having a male element on a surface thereof.

FIG. 3 is a view showing an example of a cover member and a loop thread. FIG. 3 (a) is a schematic view showing an example of a cover member used in a paint roller of the present invention. FIG. 3 (b) is a schematic view showing an example of a loop thread used in the production of the cover member of FIG. 3 (a).

FIG. 4 is a perspective schematic view showing examples of a paint roller of the present invention. FIG. 4 (a) is a perspective schematic view showing an example of a paint roller having a cover member attached all over the tubular core member. FIG. 4 (b) is a perspective schematic view showing an example of a paint roller having a plurality of pieces of the cover member of a given shape and dimension attached to the surface of the core member in a given pattern.

FIG. 5 is a schematic view illustrating a method for measuring an engagement strength between a male element on the surface of the tubular core member and a female structure on the inner surface of the cover member in EXAMPLES and COMPARATIVE EXAMPLES.

### DETAILED DESCRIPTION OF THE INVENTION

The present invention is described in more detail below, if necessary referring to the attached figures.

The present invention embraces any paint rollers, as long as the paint roller comprises a liquid-impermeable tubular core member (a liquid-impermeable tubular core part) and a cover member exchangeably attached to the surface of the core member, in such a manner that the core member and the cover member are engaged (fastened) with each other with an engagement (a male-female engagement) of a separable fastener (a hook and loop fastener). The engagement of the separable fastener comprises an engaging element with a male structure or function (hereinafter, sometimes simply referred as “a male element”) and an engaging element with a female structure or function (hereinafter, sometimes simply referred as “a female element”), and the engaging element having the male structure is formed in a given height. In this paint roller, it is sufficient that one element selected from the male element and the female element is present (or formed) on the (outer) surface of the core member, and the other element is present (or formed) on the inner surface of the cover member. For example, the paint roller may comprise a liquid-impermeable tubular core member with an engaging element having the male structure of the separable fastener on the surface of the core member, and the core member having the female element having the female structure (e.g., a loop) of the separable fastener on the inner surface of the cover member.

A typical paint roller is a one in which a number of male elements having a given height exist on a liquid-impermeable tubular core member, and a cover member having a female structure on an inner surface thereof is attached to the surface of the tubular core member by means of the engagement between the male elements and the inner surface of the cover member. The typical paint roller is described hereinafter.

The present invention embraces both paint rollers (1) and (2), which are described bellow: (1) a paint roller in which a cover member has a female structure of a separable fastener on an inner surface thereof, and the cover member is attached to all or almost all over the surface of a tubular core member having a male element by means of the engagement (a paint roller in which all or almost all over the surface of a tubular core member is covered with the cover member); and (2) a paint roller in which a cover member (a cover member piece) has a female structure of a separable fastener on the inner surface thereof, and the cover member is attached to part of the surface of a tubular core member having a male element by means of the engagement (a paint roller in which part of the surface of the tubular core member is covered with the cover member).

The above described paint roller (1) can be preferably used for, for example, a uniform painting of a surface to be painted. In the above paint roller (1), the cover member may be preferably attached to the (outer) surface of the tubular core member, preferably in a way by spirally winding the band-shaped (strip-shaped) cover member around the surface of the tubular core member with engaging or fastening the male element and the female element on the inner surface of the cover member with the engagement. In this way, the cover member can be attached firmly and stably to all over the surface of the tubular core member. Upon the painting work operation and so on, a displacement (or slippage), a peeling (or removal, separation, stripping) and the like of the cover member on the surface of the tubular core member hardly occur. Moreover, since the cover member can be wound uniformly around all over the surface of the tubular core member, it is possible to obtain a paint roller which does not generate a paint stain and the like. Incidentally, upon winding the cover member around the tubular core member, in the case where some defects are found in the winding manner (e.g., in the case where a gap occurs between the cover and tubular core members because of failure of tight winding), a paint roller realizing a uniform painting can be obtained by such a simple readjustment (or retouch) that the wound cover member is removed (or peeled off) once and wound again.

Moreover, in the above paint roller (2) of the present invention, the cover member is attached to part of the (outer) surface of the tubular core member. The paint roller (2) is preferably usable for painting a desired design or pattern on a surface to be painted. In the above-described paint roller (2), an attachment position on the surface of the tubular core member with the male element, a shape, a dimension, and the number of cover member pieces are not particularly limited to a specific one. Depending on the intended design, figure, pattern and the like on a surface to be painted, the cover member piece(s) having an appropriate shape and size can be attached simply and firmly to the surface of the tubular core member in an adequate number and positioning condition, with the engagement between the male element present on the (outer) surface and the female structure part on the inner surface of the cover member. The cover member piece(s) attached to the surface of the tubular core member can be easily exchanged for another cover member having another size, shape and the like, depending on the intended designs, figures, patterns and the like on a surface to be painted, at a painting site (place or area).

The tubular core member constituting the paint roller body of the present invention comprises a tubular core member (tube body) which is made of a liquid-impermeable material and which has a number of male elements uniformly or almost uniformly all over the surface of the roller. This tubular core member is excellent in strength and rigidity, free from deformation and damage upon the painting work operation, lightweight, and outstanding in the handling facility. Further, the material or the detail structure of the tubular core member is not particularly limited to a specific one, as long as the male element can sufficiently maintain the engagement with the female structure, without causing deformation or damage by frequent attachment and peeling operations of the cover member.

It is preferred that the tube body part of the tubular core member is made of a synthetic resin, especially a liquid-impermeable thermoplastic resin which is excellent in strength, rigidity, impact (or shock) resistance and the like. The diameter (outer diameter) of the tube body part of the tubular core member is not particularly limited to a specific one, and can be determined depending on an application, a type of usage, and the like of the paint roller. The diameter is generally about 1 to 10 cm (e.g., about 1.5 to 6 cm), preferably about 2 to 5 cm, and more preferably about 3 to 4.5 cm. The paint roller comprising a tube having such a size has an advantage in handling facility, painting facility, easy production and the like. Moreover, the length of the tubular core member of a final paint roller can be also selected depending on a usage, a using method and the like of the paint roller, and it is preferred that the length is generally about 2 to 50 cm, and preferably about 5 to 40 cm (e.g., about 10 to 40 cm), and particularly about 15 to 30 cm.

The male elements which exist on the surface of the tubular core member may be a male element derived from a woven or knitted hook-and-loop type fastening male member. It is preferred to use a male element which is the same kind or derived from a separable fastener obtained by a melt molding such as a melt extrusion molding (i.e., a male member in which a male element made of a thermoplastic resin and a basis comprising the same thermoplastic resin are bonded or attached into one piece). From the viewpoint of unraveling (or not generating snag(s)) in the male element, and easy unification by attachment and bonding of the male member sheet to the tubular core member, the same kind of male element is preferable. In the above case, it is preferred that the separable fastener male member formed by melt-molding from a thermoplastic resin such as a polypropylene-series resin (e.g., a polypropylene homopolymer and a copolymer of a polypropylene and a α-C₂-₆ olefin (e.g., ethylene)), a polyamide-series resin (e.g., a nylon 6, and a nylon 66), a polyvinyl chloride-series resin, or an aromatic polyester-series resin (e.g., a polyethylene terephthalate-series resin and a polybutylene terephthalate-series resin), because the production of the separable fastener male member is easy, and the engaging or connecting ability of the male element is high, and further the male element is excellent indurability. In particular, from the viewpoint of easy incineration in addition to the above excellent properties, the element made of the polypropylene-series resin is more preferable.

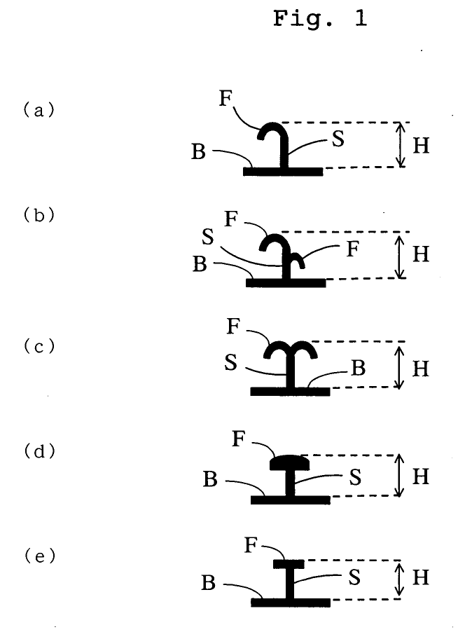

With respect to the shape and structure of the male element, depending on the shape and form of the female structure part on the inner surface of the cover member, an element having an appropriate shape and structure can be selected from a variety forms of the conventionally known male elements in order to effectively achieve the engagement between the male element and the inner surface of the cover member. The male element usually composes a support (or stem) part upstanding or extruding from a basis part (foundation part), and a fastening (latching or catching) part [or hook part, uncinate (or nail, clincher) part] formed at the top (or tip) or upper part of the support part. The shape and structure of the male element which can be employed in the present invention is not limited to a specific one, and can include, for example, a hook shape exemplified in FIGS. 1 (a) to (c), a mushroom shape exemplified in FIG. 1 (d), and a T-shape exemplified in FIG. 1 (e). The hook-shaped element may comprise (i) a support part (S) upstanding from a basis part (B) and a fastening part (F) curving or bending from the upper or top part of the support part for the basis (shown in FIG. 1 (a)), (ii) a plurality of fastening parts (F) (or a plurality of fastening parts which are different in size) curving or bending from the upper or top part as well as a middle (or halfway) part of the support part (S) for the basis (shown in FIG. 1 (b)), or (iii) a plurality of fastening parts (F) curving or bending from the upper or top part of the support part (S) for the basis. In the mushroom-shaped element shown in FIG. 1 (d), the top part of the fastening part (F) may be curved upward or may be inclined downward as an umbrella-like shape. In the T-shaped element shown in FIG. 1 (e), the fastening part of the top part may comprise a single bar-shaped body, or a plurality of bar-shaped bodies extruding in different directions (or orientations) (radial bar-shaped bodies).

The height of the male element is 0.3 to 4.0 mm (e.g., 0.4 to 3 mm), preferably 0.5 to 2.5 mm (e.g., 0.6 to 2 mm), and more preferably 0.5 to 1.5 mm. In the case where the height of the male element is less than 0.3 mm, the engagement strength between the male element and the female structure part on the inner surface of the cover member decreases, and the cover member is peeled from the core member with a small external force, resulting in difficulty of the painting work operation. On the other hand, in the case where the height of the male element is over 4.0 mm, due to a gap caused between the surface of the tubular core member and the cover member attached to the core surface in the engagement, the paint enters into the gap and the leakage of the paint occurs. As a result, the painting work operation cannot be conducted smoothly.

Incidentally, the height of the “male element” used herein refers to the distance between the surface of the basis from which the male element is upstanding and the top part (the highest part) of the male element. Referring to the male elements in FIGS. 1 (a) to (e) for explanation, the height of the “male element” denotes a height (or dimension) shown by “H” in each Figure.

The density of the male element should be selected depending on a shape and structure of the male element, a height of the male element, a dimension of the engaging part of the male element, a thickness dimension and diameter of the male element, a structure and density of the female part on the inner surface of the cover member, and the like. In general, the density of the male element is preferably about 30 to 150/cm² (e.g., about 50 to 120/cm²), and particularly about 60 to 100/cm². The male element having such a density contributes to an effective engagement between the male element and the female structure part on the inner surface of the cover member. Moreover, in the case where the cover member needs to be smoothly peeled from the tubular core member, the cover member can be peeled from the core member without applying an excessive force damaging the inner surface of the cover member and the male element itself.

The process for producing a tubular core member constituting the paint roller of the present invention is not particularly limited to a specific one, the core member may be produced by using any processes capable of producing the tubular core member having the above described structure. Among a variety of production processes, a preferably employed one is a process for producing a tubular core member having a male element on a surface thereof. That is, the tubular core member is producible by winding a strip-shaped male tape with the male element around the surface of a synthetic resin tubular object (tube body) with applying a solvent-free adhesive (especially hot-melt adhesive) to the surface of the tube. This process is excellent in working efficiency and productivity. Moreover, the process does not require a solvent-containing adhesive which causes the deterioration of the working environment, pollution of natural environment, and the like.

In the above case, a pre-produced synthetic resin tubular object (tube body) may be used as a synthetic resin tubular object, or the male tape with the male element on the outer surface may be wound around and adhered to the tubular object, while producing the tubular object. In view of further improvement in productivity by making the steps continuous, the latter process for producing the tubular object synchronized with the winding the strip-shaped male tape is desired. In particular, the following production process is preferred.

That is, a process comprising the following steps is particularly preferred: (i) spirally winding a strip-shaped sheet (band-shaped sheet, tape) comprising a thermoplastic resin around a mandrel to form a tubular object (tube-shaped object), (ii) with supplying a molten (heat-softened) thermoplastic resin in the form of a tape (band-shaped film), spirally winding the molten thermoplastic resin onto the strip-shaped sheet or around the tubular object to cover the strip-shaped sheet or the tubular object to form an adhesive layer, and (iii) further winding a strip-shaped male tape which has a male element on the surface and is made of a thermoplastic resin around the molten thermoplastic resin tape or the adhesive layer, with the male element facing outer surface. The process ensures to produce smoothly a tubular core member having the male element on the outer surface thereof in good workability and higher productivity. In the process, with winding spirally the strip-shaped sheet around the mandrel, the molten thermoplastic resin tape may be spirally wound around to at least partially overlap the edge part of the underlying strip-shaped sheet, and at the same time, the male tape may be spirally wound around to at least partially overlap the edge part of the molten thermoplastic resin tape. Moreover, upon winding the strip-shaped sheet, the molten thermoplastic resin tape, and the male tape, each of them is closely wound with overlapping the adjacent edge in many cases. Incidentally, the widths of the strip-shaped sheet, the molten thermoplastic resin tape, and the male tape may be the same or different from each other.

The synthetic resin constituting the above tubular core member may be any resins, as long as the synthetic resin is excellent in strength, rigidity, impact resistance, and lightness in weight, and has liquid-impermeability. The synthetic resin may be especially a thermoplastic resin. The synthetic resin may include, for example, a polypropylene-series resin (e.g., a polypropylene homopolymer and a copolymer of a polypropylene and an α-C₂₋₆olefin (e.g., ethylene)), an aromatic polyester-series resin (e.g., a polyethylene terephthalate-series resin and a polybutylene terephthalate-series resin), a polyamide-series resin (e.g., a nylon 6 and a nylon 66), and a polyvinyl chloride-series resin. Among these resins, the polypropylene is preferred in view of incineration. In the above process employing the mandrel, constitution of all of the strip-shaped sheet for making the tubular object, the thermoplastic resin for use as a hot melt adhesive, and the thermoplastic resin male tape with a common resin (especially, the polypropylene-series resin) contributes to further improvement in the adhesion and unification between the tubular object (tube-shaped object) and the male tape wound thereon, as well as high duration in the tubular core member with the male element. Moreover, the male element comprising a polypropylene and existing on the surface of the tubular core member hardly causes deformation and damage, and maintains its engaging function over a long period.

The cover member to be attached to the surface of the tubular core member may be any cover members, as long as the cover member is excellent in the holding capacity of a paint as well as the painting performance, has the female structure (or female element) on the inner surface of the cover member for connecting to the male element on the surface of the tubular core member, and comprises a material excellent indurability for painting work operation. As the cover member, a fabric may be preferably used in view of good paint-holding capacity and excellent painting performance, and easy formation of the inner surface having the female structure. As the cover member of the paint roller, a woven fabric is conventionally used. According to the present invention, however, either a woven fabric or a non-woven fabric can be utilized for the cover member. A loop or an entangled fiber of the cover member can be utilized as the female element.

The surface (upper surface or outer surface) of the cover member may or may not have a pile(s) (or a raising(s)). From the viewpoint of the paint-holding capacity or the painting uniformity, it is preferred that the surface has a pile (or a raising).

According to the present invention, the cover member may include: (1) a single layered cover member (fabric) in which the female element having the female structure is present (formed) on the inner surface in the process for producing the cover member (fabric) [i.e., a cover member (fabric) which is produced as to express the female structure on the inner surface of the cover member (fabric) all at once (simultaneously)]; or (2) a laminated cover member (laminated fabric) which comprises a fabric and a sheet or fabric having a female structure of a separable fastener [a cover member (laminated fabric) which is produced by preparing or fabricating a fabric such as a pile fabric having the paint-holding capacity and the uniform painting in advance, and bonding (laminating) another sheet or fabric having the female structure of the separable fastener to the inner surface of the fabric].

In particular, it is preferred to use the above cover member (fabric) (1), because the above cover member (fabric) can be produced in an economical manner by a simple process and a simple equipment, without costing labor and time.

The process for producing the cover member (1) is not particularly limited to a specific one, and the cover member may be produced by any processes, as long as a cover member (fabric) having a female structure on the inner surface can be produced, and such a cover member is excellent in a paint-holding capacity or a uniform painting. Especially, the cover member is producible smoothly and in good productivity according to the following process.

That is, there may be preferably used a process for producing the cover member (fabric) (1), which comprises interlacing (weaving or knitting) a base (a ground) by using a thread having a loop (hereinafter, sometimes referred simply as “a loop thread”) as at least part of a thread (a ground yarn) for a base. In this process, a fabric having a lot of small loops exposed on the inner surface of the cover member (fabric) can be formed, and these loops exhibit the female structure (female element). As a result, the cover member is attachable to the surface of the tubular core member by the engagement between the female element and the male element existing on the surface of the tubular core member.

In the above cover member (1), in order to achieve a sufficient engagement strength between the loop and the male element on the inner surface of the tubular core member, when the number of male elements on the tubular core member per unit area is regarded as A pieces per cm² (A/cm²), it is preferred that the number of loops (female elements) exposed on the back is usually, 0.5 A to 3 A/cm², and particularly 1 A to 2.5 A/cm².

In addition, the size of the loop (female element) exposed on the inner surface of the cover member should be adjusted to the size which realizes the good engagement therebetween, depending on the shape or size (height, diameter, thickness and soon), the degree of the flexibility and the like of the male element on the surface of the tubular core member. The size of the loop (the diameter of the loop) exposed on the inner surface of the cover member is generally about 100 μm to 3 mm (e.g., about 0.1 to 2.5 mm, and preferably about 0.3 to 2 mm).

The number, the size, and the like of loops to be exposed on the inner surface of the cover member (fabric) can be determined by adjusting the number or the size of loops in the loop thread for the base, the number of loop threads used in producing the cover member (fabric), the kind of the weaving ground or knitting ground, the weight of the cover member (fabric), the density of the loop, and the like.

The loop thread used in weaving or knitting the base can be fabricated, for example, through a known process comprising supplying a plurality of filaments to a entangling (or entwining) apparatus in different rates with each other, and entangling a filament(s) supplied in the slower rate around a filament supplied in the faster rate to form the loops.

The average number of loops (female elements) in 1 cm of the loop thread used for producing the cover member (fabric) is about 5 to 100 (e.g., about 7 to 70), preferably about 10 to 50, and more preferably about 15 to 40 (e.g., about 20 to 40). Use of such a loop thread realizes a cover member (fabric) having excellent female structures on the inner surface thereof.

A fabric (cover member) having a female structure on the inner surface (under or lower surface) thereof and a pile on the upper surface thereof can be obtained by weaving or knitting the above fabric (base) (1) with the loop having the female structure on the inner surface thereof, through a thread for piling in the process of weaving or knitting the fabric.

Moreover, the above cover member (fabric) (2) can be produced, for example, by producing (a) a fabric with a pile on the surface in advance, and laminating (b) another fabric which is previously formed and has a female structure on the inner surface of the fabric (a), by means of a laminating process (or lamination) or other suitable processes. In such a case, the fabric (b) having the female structure on the inner surface thereof may include, for example, a raising tricot fabric produced by using a false-twist finished yarn and the like. The raising surface of the raising tricot fabric has a good male-female engaging action with the male element on the surface of the tubular core member.

The height, the number (pile density per unit area) and the like of piles on the upper surface of the cover member can be selected in the same way as the conventional paint roller, depending on a kind of the paint roller, a kind of the paint to be applied with the paint roller, a type of usage, and the like. The height of the pile is generally about 3 to 30 mm, and particularly about 5 to 25 mm (e.g., about 5 to 15 mm). The density of the pile can be selected within a range about 10 to 100/cm², and may be about 15 to 80/cm² (e.g., about 18 to 80/cm²), particularly about 20 to 50/cm², and may be about 15 to 40/cm². The cover member having such a pile is preferred in term of the paint-holding capacity, the painting uniformity, and the like.

The pile on the surface of the cover member is preferably a cut pile rather than a loop pile, in term of the paint-holding capacity, the painting uniformity, the discharging facility and the like.

Alternatively, in the above cover member (fabric) (1) having the loop exposed on the inner surface, (i) a fiber which constitutes the loop derived from the loop thread, (ii) other fibers constituting the base, and (iii) a fiber constituting a pile may be same or different from each other.

In the both cover members (1) and (2), the base and the pile of the fabric constituting the cover member can be, for example, made of a synthetic fiber such as a polypropylene fiber, a polyester fiber (e.g., a polyethylene terephthalate-series fiber and a polybutylene terephthalate-series fiber) or a polyamide fiber (e.g., a nylon 6 fiber and a nylon 66 fiber), or a combination thereof. Among these fibers, the polyamide fiber and/or the polyester fiber are preferred in term of the paint-holding capacity and the like.

The single fiber fineness (or size) of the fiber forming the base and the pile in the fabric constituting the cover member is not particularly limited to a specific one, and it is preferred that the fineness is about 1 to 20 dtex (e.g., about 3 to 15 dtex) alike to a conventional paint roller.

In the cover member used in the present invention, especially the cover member with the pile on the surface, it is important that the fiber such as the pile is not drop (shed, come off, or fall out) during the painting work operation (the fiber shedding does not occur), in order to form a good painted surface. Thus, it is necessary to prevent the pile from shedding from the cover member.

In a usual pile product such as a carpet, the product is generally treated on the under surface thereof with a resin coating called a backing in order to prevent the pile from shedding. However, in the cover member used in the present invention, since the cover member comprises a loop(s) having the female structure and being exposed on the inner surface of the cover member, or other fiber(s) having the female structure and existing in the inner surface of the cover member, by such a backing process, the loop as well as the other fiber is buried into the resin coating layer (backing layer). Thus since the loop and other fiber cannot realize the female structure, the backing process employed in the usual pile product such as a carpet cannot be applied to the cover member of the present invention.

Therefore, in order to avoid falling out the pile on the surface of the cover member, the present invention preferably adopts a process which comprises preparing a cover member (fabric) containing a heat-fusing fiber in the base by using a heat-fusing fiber (a thread comprising a heat-fusing fiber) as one kind of a ground yarn constituting the base, melting (or fusing) the cover member (fabric) with heating at a the temperature of not lower than the melting point of the heat-fusing fiber, and welding the molten heat-fusing fibers among themselves as well as the molten heat-fusing fiber with a fiber forming a pile and the like or with other fibers in the base. Use of the above process realizes the avoidance of the displacement of the loop exposed on the inner surface of the cover member because of the prevention of the pile from falling out and the firm welding of the loop thread in the base. Thereby the engagement can be more effectively exhibited.

Further, use of the heat-fusing fiber (or a hot-melt adhesive fiber) ensures the repression of the variation in the width of the cover member due to the tension applied to the cover member during winding the cover member around the core member caused by melting and welding between fibers in the base.

The proportion of the heat-fusing fiber in the cover member is not limited to a specific one, and may be generally about 10 to 100% by mass (e.g., about 20 to 80% by mass), preferably about 30 to 100% by mass (e.g., about 30 to 80% by mass), and more preferably about 40 to 100% by mass (e.g., about 40 to 80% by mass), relative to a total mass of the thread constituting the base. It is preferred to use the heat-fusing fiber in such a proportion in term of function for welding the pile, the dimensional stability of the cover member, and the like.

As the heat-fusing fiber, there may be used a fiber constituting a foundation (substrate) of the base, or a fiber excellent in the heat-weldability with the pile thread forming the pile, and at least part of the fiber is molten (softened or fused) at a lower temperature. The heat-fusing fiber is not limited to a specific one, and for example, may include a conjugated fiber having a sheath-core or a sea-island structure, in which a sheath component or an ocean component comprises a lower melting point resin having a hot-melt adhesive property and a core component or an island component comprises a higher melting point resin; and a mixed spun fiber thereof. Such a fiber may include a conjugated fiber having a sheath-core or a sea-island structure, in which a sheath component or an ocean component comprises a polyethylene-series resin and a core component or an island component comprises a polypropylene-series resin (e.g., a polypropylene homopolymer, and a copolymer of a polypropylene and an α-C₂₋₆ olefin (e.g., an ethylene)), and a mixed spun fiber thereof; a conjugated fiber having a sheath-core or a sea-island structure, in which a sheath component or an ocean component comprises an ethylene-vinyl alcohol copolymer and a core component or an island component comprises a polypropylene-series resin (e.g., a homo- or co-polymer of the polypropylene), a polyester-series resin (e.g., an aromatic polyester-series resin such as a polyethylene terephthalate-series resin or a polybutylene terephthalate-series resin) or a polyamide-series resin (e.g., an aliphatic polyamide-series resin such as a nylon 6 or a nylon 66, and an aromatic polyamide-series resin such as an MXD-6), and a mixed spun fiber thereof; a conjugated fiber having a sheath-core or a sea-island structure, in which a sheath component or an ocean component comprises a polyester-series resin having a lower melting point (e.g., a polyester-series resin using a long chain alkanediol, a long chain aliphatic dicarboxylic acid, and an asymmetric aromatic dicarboxylic acid such as an isophthalic acid) and a core component or an island component comprises a polyester-series resin having a higher melting point (e.g., the aromatic polyester-series resin) and a mixed spun fiber thereof; a conjugated fiber having a sheath-core or a sea-island structure, in which a sheath component or an ocean component comprises a lower melting point polyamide-series resin (e.g., a polyamide-series resin using a long chain aliphatic dicarboxylic acid) and a core component or an island component comprises a higher melting point polyamide-series resin (e.g., the aliphatic polyamide-series resin and the aromatic polyamide-series resin), and a mixed spun fiber; and others.

The resin having a lower melting point and the resin having a higher melting point may be crystalline or amorphous (or noncrystalline). The melting point (or Vicat softening point) of the lower melting point resin measured by a differential scanning calorimeter is, for example, about 70 to 170° C., preferably about 80 to 150° C., and more preferably about 90 to 140° C. (e.g., about 100 to 130° C.), and the difference in the melting points between the higher melting point resin and the lower melting point resin (or difference in the Vicat softening points) may be, for example, about 20 to 150° C., preferably about 25 to 120° C., and more preferably about 30 to 100° C.

According to the present invention, a non-woven fabric in addition to the above fabric comprising a woven fabric is used as the base, can be also used as the cover member. In the non-woven fabric, the loops constituting the female structure (female member or female element) involved in the engagement are not exposed. However, since the fibers in the non-woven fabric are randomly entangled with each other and fixed, when the male element on the outer surface of the tubular core member digs into the inside from the inner surface of the non-woven fabric, the male element is hooked on the entangled fibers to give the engagement. Therefore, the female element having the female structure can comprise the entangled fibers, and the cover member comprising the non-woven fabric can be fixed and attached to the surface of the tubular core member by the engagement between the cover member and the male element on the surface of the tubular core member.

Incidentally, in some cases, a short fiber fallen off from the cover member comprising the non-woven fabric may soil (or make dirty) the painted surface. Thus, depending on the required performance of a surface to be painted, it is preferred to use a non-woven fabric as the cover member in the case of not causing any problems.

Moreover, an attention should be paid for using a non-woven fabric as the cover member because the non-woven fabric generates a line on the painted surface due to a wound joint on the surface of the tubular core member, the wound joint which is caused by winding the non-woven fabric around the tubular core member and is sometimes remained. However, in an effect roller in which the cover member cut into a given size and dimension, is attached to the surface of the tubular core member in a given pattern, there is no problem by nature so that the non-woven fabric can also be used efficiently as the cover member.

The thickness, the weight, and the like of the cover member are not particularly limited to a specific one, and can be selected based on a kind, an application, a type of use and the like of the paint roller. From the viewpoint of the paint-holding capacity, the painting uniformity, the handleability, the winding property and the like, the thickness of the cover member is generally about 2 to 30 mm (e.g., about 3 to 25 mm), preferably about 4 to 25 mm (e.g., about 4 to 20 mm), and more preferably about 4 to 15 mm (e.g., about 5 to 10 mm) [in the case where the cover member is a pile fabric, the thickness includes the pile part], and the weight is about 200 to 1000 g/m² (e.g., about 300 to 900 g/m²) and preferably about 400 to 800 g/m², and may be about 500 to 900 g/m².

The paint roller according to the present invention is produced by the following steps: fixing the cover member having the female structure on the inner surface thereof to the surface of the tubular core member with the male element on a surface thereof by means of the engagement between the male element and the female structure on the inner surface of the cover member, to prepare a tubular body for the paint roller (preparatory roller) covered with the cover member entirely or partially; cutting the preparatory roller into a given dimension of the paint roller; and then attaching a handle thereto. The same handle as the conventionally used one can be employed as the handle to be attached, depending on an application and a type of usage of the paint roller.

In the case where the cover member comprises the pile fabric, before or after cutting the fabric into a given dimension, it is preferred that the fluff (or fuzz) is finished by brushing and others.

Upon the distribution and sale of the paint roller of the present invention, in order to exchange the cover member which becomes dirty, damaged, or worn, one or a plurality (not less than two) of a spare (replacement) cover member may be distributed or sold in combination with the paint roller. Moreover, the cover member alone may be distributed or sold as “a cover member for a paint roller”, so that a user of the paint roller can separately buy only the cover member to exchange the old cover member which becomes dirty, damaged, or worn.

The present invention is illustrated in detail referring to the drawings as following, but the present invention is not limited to these specific examples in any way.

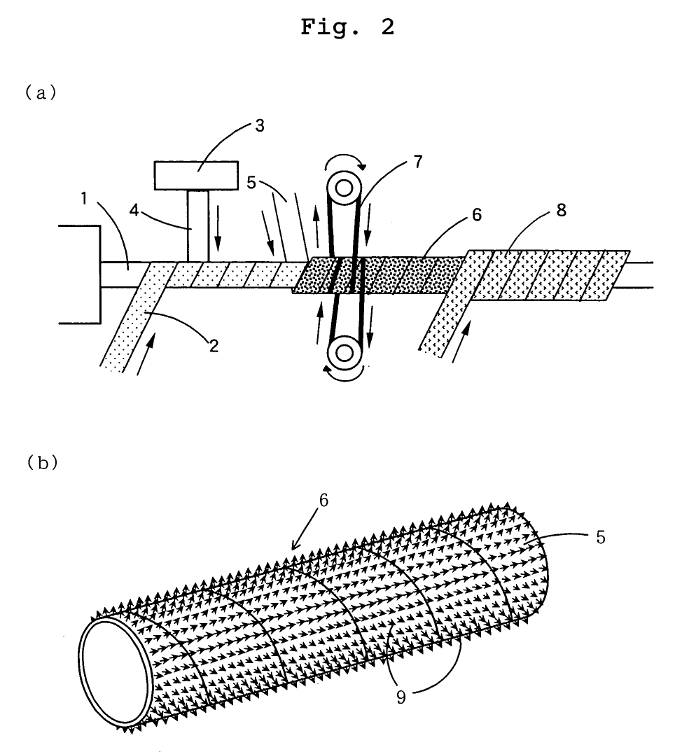

FIG. 2 is a view showing a process for producing a tubular body (preparatory roller) for a paint roller, and an example of a tubular core member produced by this process. FIG. 2 (a) is a schematic view showing an example of a process for producing a tubular body (preparatory roller) for a paint roller which comprises a tubular core member and a cover member, in which the cover member is attached (fixed) to the surface of tubular core member. FIG. 2 (b) is a perspective schematic view showing an example of a tubular core member having a male element on a surface thereof.

In FIG. 2, symbol 1 shows anon-rotating (or static) mandrel; symbol 2 shows a strip-shaped sheet (tape) comprising a thermoplastic resin such as a polypropylene; symbol 3 shows an applicator for supplying a molten thermoplastic resin (e.g., a polypropylene) in the tape-shaped (band-shaped) form; symbol 4 shows a molten thermoplastic resin tape; symbol 5 shows a male tape comprising a thermoplastic resin such as polypropylene, with a male element on the outer surface; symbol 6 shows a tubular core member with the male element on a surface thereof; symbol 7 shows a feeding belt for rotating the tubular core member 6 around the mandrel 1 and displacing downstream the tubular core member 6; symbol 8 shows a cover member; and symbol 9 shows a male element.

In the example shown in FIG. 2, the strip-shaped sheet 2 made of the thermoplastic resin is supplied at a given angle and spirally wound around the non-rotating mandrel 1, and the molten thermoplastic resin tape 4 supplied from the applicator 3 is spirally wound onto the strip-shaped sheet 2 which is wound around the mandrel 1. Further, while a molten state of the thermoplastic resin tape 4 is kept, the male tape 5 with the male element 9 on the outer surface thereof is wound spirally around the molten thermoplastic resin tape 4. By the hot-melt adhesive action of the molten thermoplastic resin tape 4, the strip-shaped tape 2 wound around the mandrel 1 is adhered to the male tape 5 and united into one piece to form the tubular core member 6 of the roller with the male element on a surface thereof as shown in FIG. 2(b). Further, the tubular core member 6 is rotated on the mandrel 1 and fed downstream by the feeding belt 7, and the cover member 8 is attached onto the surface of the tubular core member 6 by the engagement between the male element on the surface of the tubular core member 6 and the female element with spirally winding the cover member 8 around the core member 6, to produce the tubular body used in the paint roller of the present invention. Incidentally, a lubricant (or antifriction) is also dropped between the mandrel 1 and the strip-shaped sheet 2. Thereby, with the use of the slipping (or sliding) between the mandrel 1 and the sheet 2, the feeding belt 7 drives and feeds a cylindrical laminated matter (core member 6) downstream with rotating the core member 6 by using the mandrel 1 as the rotation axis. The cylindrical laminated matter (core member 6) comprises the sheet 2, the molten thermoplastic resin tape 4, and the male tape 5.

Incidentally, in the production process shown in FIG. 2 (a), upon feeding the tubular core member 6 to the downstream by the feeding belt 7 with rotating around the mandrel 1, the strip-shaped sheet 2 which exists in the upstream side of the cover member 6 is also wound around the mandrel 1, with rotating on the mandrel 1. Thereafter, the tubular body for the paint roller covered with the cover member obtained in FIG. 2 (a) is cut into a given dimension with a cutting device (not shown), and then a handle is attached to the cut tubular body to produce the paint roller. At that time, the outer surface of the cover member may be optionally brushed to finish the fluff on the outer surface thereof, before or after the cutting.

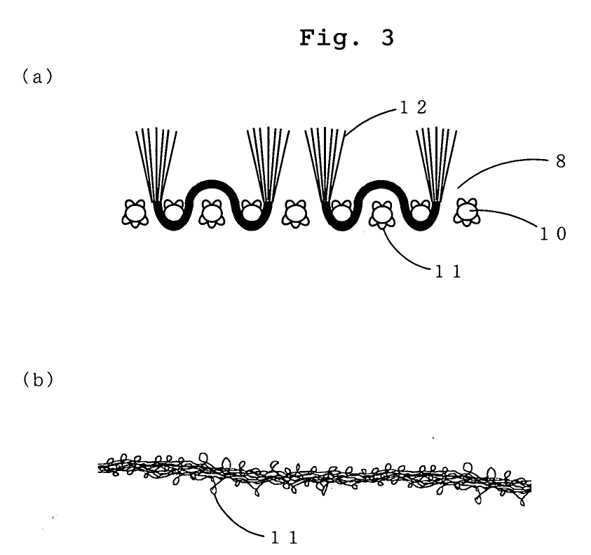

FIG. 3 is a view showing an example of a cover member, and an example of a loop thread used for the cover member. FIG. 3 (a) is a schematic view showing an example of a cover member used in a paint roller of the present invention. FIG. 3 (b) is a schematic view showing an example of a loop thread used in the production of the cover member of FIG. 3 (a). In FIG. 3, symbol 8 shows a cover member; symbol 10 shows a weft (or woof) constituting a base; symbol 11 shows a loop; and symbol 12 shows a pile.

The cover member 8 shown in FIG. 3 (a) is produced by using the loop thread illustrated in FIG. 3 (b) as the weft 10, and the loop thread constitutes part of the thread for the base upon weaving or knitting the cover member 8. The pile 12 is formed on the upper surface of the cover member 8, and many loops 11 from the weft 10 are formed with exposing on the inner surface of the cover member 8. Therefore, the loop 11 has the female structure of the female element (second element or receiving element) and is connected to the male element 9 existing on the outer surface of the tubular core member 6 shown in FIG. 2 (b) by the engagement therebetween. Thereby the cover member 8 can be stably attached to the surface of the tubular core member 6. Incidentally, the loop thread may be used as the weft and/or a warp.

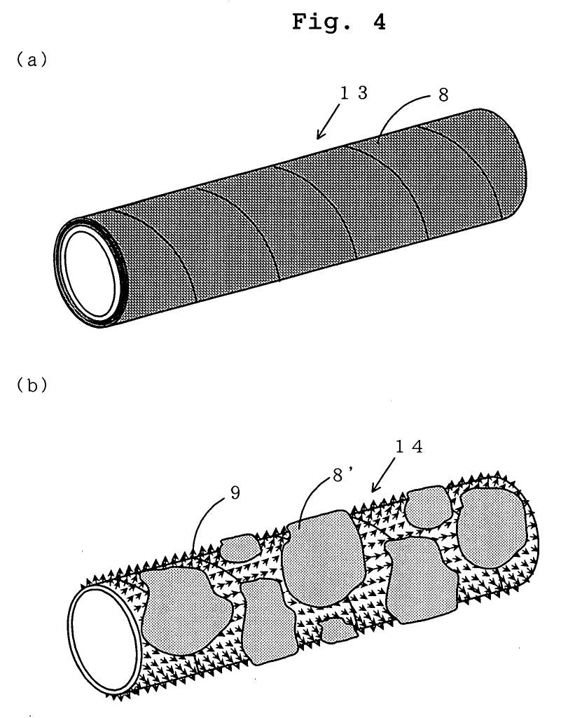

As shown in FIG. 2 (a), the cover member 8 is attached to all over the outer surface of the tubular core member 6 by winding and so on to produce a paint roller 13 (a tubular body for a paint roller) shown in FIG. 4 (a). The paint roller 13 has the tubular core member 6 covered with the cover member 8 entirely.

Moreover, as shown in FIG. 4 (b), in the case of using a cover member piece 8′ having a given shape and dimension (as a cover member 8), the cover member piece 8′ is attached to the surface of the tubular core member 6 in a given pattern by the engagement between the male element 9 and the female structure on the inner surface of the cover member piece 8′, to produce an effect roller 14 having the given pattern shown in FIG. 4 (b). In the effect roller shown in FIG. 4 (b), the kind of the pattern can be variously altered by changing the shape, the size, the arrangement, the number and others of the cover member piece 8′. Such an alteration can be easily conducted at the site of the painting working operation. Incidentally, the pattern comprising the cover member piece 8′ is not particularly limited to a specific one, and may be, for example, a pattern diffused (or scattered) regularly or randomly in vertical and horizontal directions on the surface of the tubular core member 6 of the roller, or a continuous or diffused pattern in axial and/or circumferential directions (or longitudinal and/or latitudinal directions) on the tubular core member 6.

Incidentally, the above example illustrates a case where the liquid-impermeable tubular core member has the male element on the outer surface thereof, and the cover member has the female element on the inner surface thereof. In the present invention, one of element selected from the group consisting of the male element and the female element may be formed on the surface of the core member, and the other element may be formed on the inner surface of the cover member, such that the cover member is exchangeable for the core member by the engagement between the male element and the female element. For example, the core member may have the female element (e.g., a loop, a entangling fiber, and the like) on the surface thereof, and the cover member may have the male element (e.g., a hook-shaped element) on the inner surface thereof.

The process for producing the tubular core member is also not limited to the above process. The core member having one element selected from the group consisting of a male element and a female element on a surface thereof may be produced by winding spirally at least a molten thermoplastic resin tape, and one tape selected from the group consisting of the male tape having the male element and the female tape having the female element around the mandrel for laminating sequentially; and feeding the cylindrical laminated matter downstream by the feeding belt with rotating on the mandrel as a rotation axis.

### INDUSTRIAL APPLICABILITY

The paint roller of the present invention is useful for a resource-saving paint roller, because the dirty, damaged, or worn cover member is removable from the surface of the tubular core member and easily exchangeable for a new cover member, such that the tubular core member is usable repeatedly. Moreover, the paint roller of the present invention is useful for an effect roller which can freely and conveniently change a painting pattern to be painted on a surface of an object, because the paint roller comprises a cover member piece having a given shape and dimension, as the cover member for attaching to the surface of the tubular core member.

### EXAMPLES

The following examples are intended to describe this invention in further detail and should by no means be interpreted as defining the scope of the invention.

In the following examples, the measurement and evaluation was carried out as below.

(1) Measurement of the Height of the Male Element

The male element part formed on the male tape was observed with a Digital HF microscope (“VH-8000” manufactured by Keyence Corporation) at the 50-power magnification to measure the distance between the bonding part of the support of the male element to the sheet-shaped basis and the highest part (top) of the male element (height (H) shown in FIG. 1), and the measured value was expressed as the height of the male element (mm).

(2) Measurement of the Engagement Strength

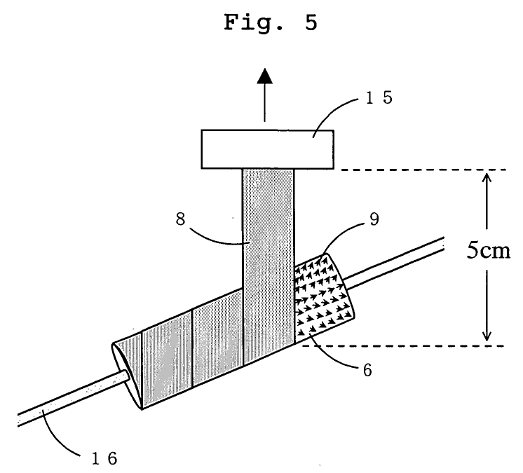

As shown in FIG. 5, in the paint roller comprising the tubular core member 6 of the roller and the cover member 8 wound spirally around the surface of the core member, the cover member 8 was peeled by 5 cm from the tubular core member 6, one end thereof was grasped with a chuck of an Instron testing machine (“Auto AGS-100” manufactured by Shimadzu Corporation) in a width (width in the vertical (perpendicular) direction) of 1 cm, then an iron core 16 was put through the tubular core member 6, both ends of the iron core 16 were fixed. After that, the chuck 15 of Instron testing machine was lifted at a rate of 300 mm/min. to measure the peel strength at that time as the engagement strength. Incidentally, as the chuck 15 is elevated, the cover member 8 is peeled from the surface of the tubular core member 6 with rotating.

(3) Assessment of the Painting Performance:

A paint (160 g, “One-component Fine Urethane U100” manufactured by Nippon Paint Co., Ltd.) was held on the surface of a paint roller, the paint roller was reciprocated 100 times (there and back) on a coated paper (100 times there and back on the same zone of the paper) to paint the paper, and the aesthetics (appearance) of a paint film finished was visually observed and evaluated.

### Example 1

(1) Production of a Loop Thread:

One nylon filament thread (140 dtex/14 filaments; manufactured by Toray industries, Inc.) as a sheath thread and one heat-fusing fiber (a sheath-core type conjugated fiber in which the core component comprised a polyethylene terephthalate and the sheath component comprised an ethylene-vinyl alcohol-series copolymer; 165 dtex/48 filaments) as a core thread was fed to Taslan (a registered trademark of Heberlein Fiber Technology Inc.) nozzle (“#15” manufactured by Heberlein) at a feed rate of the core thread of 1.10 and a feeding rate of the sheath thread of 1.50, and subjected to Taslan process under an air pressure of 540 kPa (5.5 kg/cm²) and a processing speed of 200 m/min. to produce a process thread (loop thread) having 410 dtex/62 filaments (the average loop number per cm of the thread: 22).

(2) Production of a Cover Member

Two polyester filament threads (276 dtex/48 filaments) were provided for pile threads. One loop thread obtained from the above (1) and one heat-fusing thread (filament thread; 165 dtex/48 filaments; “Sophista” manufactured by Kuraray Co., Ltd.) were used as ground yarns. The above ground yarns (the loop thread and the heat-fusing thread) were pulled and aligned and knitted with a circular knitting machine with applying a tension of 10 g to the heat-fusing fiber filament to give a cover member (woven fabric) having a pile made of the polyester filament thread on the upper surface (pile density: 21/cm², average pile height: 7 mm), and having many loops of nylon filament exposed on the inner surface (weight of the woven fabric: 560 g/m², thickness of the woven fabric: 6 mm).

(3) Production of a Paint Roller

(i) As shown in FIG. 2 (a), a strip-shaped polypropylene sheet in a width of 50 mm was wound spirally around a mandrel 1 (outer diameter of 3.8 cmφ), while allowing a heat-fused (molten) polypropylene in the form of a tape to flow down from an applicator 3 onto the sheet in an application amount of 0.03 g/cm² and apply the molten polypropylene for spirally winding around the strip-shaped polypropylene sheet, and then a male tape of a separable fastener made of a polypropylene in a width of 50 mm (height of a male element: 0.7 mm, density of a male element: 81/cm²) (“MAGILOCK” manufactured by Kuraray Co., Ltd.) was spirally wound and fixed around the molten polypropylene (in an angle of 21√ relative to the central axis of the mandrel 1).

(ii) Followed by the above step (i), the cover member obtained from the above (2) (cover member slit into a width of 50 mm) was spirally (in an angle of 21° relative to the central axis of the mandrel 1) wound around the surface of the wound male tape, and the cover member was attached to the surface of the core member with an engagement between the male element of the separable fastener male tape and the inner surface of the cover member to fabricate a tubular body for the paint roller covered with the cover member on the whole surface thereof.

(iii) After cutting the tubular body for the paint roller fabricated in the above (ii) into 23 cm, brushing the surface to condition the fluff, followed by attaching a spring handle to the body, a paint roller was produced.

(iv) For the paint roller produced in the above (iii), the engagement strength was measured by the above method prior to the attachment of the handle. As a result, the peeling strength was 10 to 26 g/cm, and it was confirmed that the cover member was sufficiently engaged with the surface of the tubular core member with the male element on the outer surface.

Moreover, the painting performance of the paint roller produced in the above (iii) was evaluated by the above method after the attachment of the handle. As a result, the painted surface did not have a transfer of the joint of winding. Thus, the paint roller was excellent in the painting performance. Moreover, the paint did not enter into the boundary portion of the tubular core member of the paint roller and the cover member upon the painting, and any problems such as a paint leakage did not occur.

### Example 2

(1) The same cover member as those obtained in EXAMPLE 1 (2) was adequately cut into a scrollwork pattern and a geometrical pattern to give a plurality of cover member pieces.

(2) A tubular core member with the male element on a surface thereof was produced by the same step as in EXAMPLE 1 (i), and this preparatory core member was directly cut into length of 23 cm (without attaching the cover member) to produce a tubular core member having the given length (23 cm).

(3) The plurality of cover member pieces produced in the above (1) were attached to the surface of the tubular core member in length of 23 cm produced in the above (2) at a space from each other, to give a effect roller.

(4) The painting with the effect roller produced in above (3) achieved that the same pattern design as the pattern on the surface of the effect roller was smoothly painted on a surface to be painted.

### Example 3

(1) Production of the Cover Member

(i) Two polyester filament threads (276 dtex/48 filaments) were provided for pile threads. Two polyester false-twisted filament thread (220 dtex/72 filaments) and one heat-fusing fiber filament (filament thread; 165 dtex/48 filaments; “Sophista” manufactured by Kuraray Co., Ltd.) were used as ground yarns. The above ground yarns were aligned and knitted with a circular knitting machine to give a woven fabric having a pile made of the polyester filament thread on the upper surface (weight of the woven fabric: 540 g/m², thickness of the woven fabric: 7 mm, pile density on the upper surface: 22/cm², and average pile height: 7 mm).

(ii) With the use of a polyester false-twisted thread (80 dtex/24 filaments), a tricot fabric (weight of the woven fabric: 150 g/m², thickness of the woven fabric: 1.5 mm) was produced, then one surface of the tricot fabric was raised with a raising machine to produce a tricot raising fabric.

(iii) The non-raising surface of the tricot raising fabric produced in above (ii) was adhered to the non-piloerected surface (the surface having no pile formed) of the fabric produced in the above (i) by using a “Dynac” manufactured by Toyobo Co., Ltd. as an adhesive to laminate both fabrics, to give a laminated fabric (cover member).

(2) Production of the Paint Roller:

(i) A paint roller was produced in same way as in EXAMPLE 1, except that using the laminated fabric produced in the above (1) (ii) as the cover member.

(ii) For the paint roller produced in the above (i), the engagement strength was measured according to the above process. As a result, the strength upon peeling was 67 to 121 g/cm, and it was confirmed that the cover member was engaged with the surface of the tubular core member of the paint roller with the male element on the outer surface, in high engagement strength.

Moreover, the painting performance of the paint roller produced in the above (i) was evaluated by the above method. As a result, the painted surface did not have a transfer of the joint of winding, and the paint roller was excellent in the painting performance. Moreover, the paint did not enter into the boundary portion of the tubular core member of the paint roller and the cover member upon the painting, and any problems such as a paint leakage did not occur.

### Comparative Example 1

(i) A paint roller was produced in the same manner as EXAMPLE 1, except for using a separable fastener male tape (“MAGILOCK” manufactured by Kuraray Co., Ltd.) in which the height of the male element is 4.5 mm and the density of the male element is 81/cm², as a polypropylene separable fastener male tape.

(ii) For the paint roller produced in the above (i), the engagement strength was measured according to the above method. As a result, the strength upon peeling was 10 to 21 g/cm, and it was confirmed that the cover member was engaged with the surface of the tubular core member with the male element on the outer surface, in the sufficient engagement strength. However, the paint entered into the gap or void at the boundary between the tubular core member and the cover member upon painting, and a paint leakage occurred. As a result, a regular diagonal line appeared on the painted surface, and the paint roller could not perform a uniform painting.

### Comparative Example 2

(i) A paint roller was produced in the same manner as EXAMPLE 1, except for using a separable fastener male tape (“MAGILOCK” manufactured by Kuraray Co., Ltd.) in which the height of the male element is 0.1 mm and the density of the male element is 81/cm², as a polypropylene separable fastener male tape.

(ii) For the paint roller produced in the above (i), the engagement strength was measured according to the above method. As a result, the strength upon peeling was extremely low, 1 to 4 g/cm, that is, the male element on the surface of the tubular core member was hardly engaged with the inner surface of the cover member.

1. A paint roller comprising a liquid-impermeable tubular core member and a cover member attached exchangeably on the surface of the core member, wherein the core member is attached to the cover member with an engagement of a separable fastener which comprises a male element and a female element, and the height of the male element is 0.3 to 4.0 mm.

2. The paint roller according to claim 1, wherein one element selected from the group consisting of the male element and the female element is present on the surface of the core member, and the other element is present on the inner surface of the cover member.

3. The paint roller according to claim 1, which comprises the liquid-impermeable core member and the cover member, wherein the core member comprises the male element on the surface, and the cover member comprises a loop having the female structure on the inner surface of the cover member.

4. The paint roller according to claim 1, wherein the density of the male element is 30 to 150 per cm².

5. The paint roller according to claim 2, wherein the density of the male element on the surface of the core member is 30 to 150 per cm².

6. The paint roller according to claim 1, wherein the cover member is spirally wound around the surface of the core member for being attached to the core member.

7. The paint roller according to claim 1, wherein the cover member is attached in a given pattern on the surface of the core member.

8. The paint roller according to claim 1, in which the core member comprises a separable fastener tape and a tubular object, wherein the fastener tape is spirally wound around the surface of the tubular object, and the fastener tape has one element selected from the group consisting of the male element and the female element on a surface thereof.

9. The paint roller according to claim 1, in which the core member comprises a separable fastener tape and a tubular object, wherein the fastener tape is spirally wound around the surface of the tubular object, and the fastener tape has the male element on a surface thereof.

10. The paint roller according to claim 8, wherein the tubular object and the separable fastener tape are made of a synthetic resin.

11. The paint roller according to claim 1, wherein the cover member is a fabric having a pile on an upper surface thereof and having a loop on an under surface thereof, wherein the loop is engaged with the male element on the surface of the core member with the engagement. knit weave

12. The paint roller according to claim 1, wherein the cover member comprises a base which is woven or knitted from at least a thread having a loop.

13. The paint roller according to claim 1, wherein the cover member is a fabric having a loop on an inner surface thereof, and the loop is capable of engaging with the male element on a surface of the core member by means of the engagement.

14. The paint roller according to claim 1, wherein the cover member is a fabric having a pile on an upper surface thereof and containing a heat-fusing fiber in a base constituting the fabric, and wherein in the base, the heat-fusing fiber is heat-welded together with other heat-fusing fiber, as well as with other fiber.
